(19) United States
(12) Patent Application Publication
(10) Pub. No.: US 2019/0200349 A1
(43) Pub. Date: Jun. 27, 2019

(54) USER TERMINAL AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Jing Wang, Tokyo (JP); Liu Liu, Beijing (CN); Huiling Jiang, Beijing (CN)

(73) Assignee: NTT DOCOMO, INC., Tokyo (JP)

(21) Appl. No.: 16/331,900

(22) PCT Filed: Sep. 7, 2017
(86) PCT No.: PCT/JP2017/032189

§ 371 Date: Mar. 8, 2019

(30) Foreign Application Priority Data
Sep. 9, 2016 (JP) 2016-176859

(51) Int. Cl. H04W 72/04

(52) U.S. Cl. CPC H04W 72/0413

(57) ABSTRACT

The present invention is designed so that uplink control channels can be transmitted adequately even in carriers in which listening is required prior to transmission. A user terminal according to one example of the present invention communicates in a plurality of cells, including at least one uplink control channel-configured cell in which an uplink control channel is configured, and this user terminal has a measurement section that executes listening for two or more cells among the plurality of cells, in a given period, and a control section that controls to transmit an uplink control signal in at least one cell where listening has succeeded.

### TECHNICAL FIELD

The present invention relates to a user terminal and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower latency and so on (see non-patent literature 1). Also, the specifications of LTE-A (also referred to as “LTE-advanced,” “LTE Rel. 10,” “LTE Rel. 11,” or “LTE Rel. 12”) have been drafted for further broadbandization and increased speed beyond LTE (also referred to as “LTE Rel. 8” or “LTE Rel. 9”), and successor systems of LTE (also referred to as, for example, “FRA (Future Radio Access),” “5G (5th Generation mobile communication system),” “5G+(plus),” “NR (New Radio),” “NX (New radio access),” “New RAT (Radio Access Technology),” “FX (Future generation radio access),” “LTE Rel. 13,” “LTE Rel. 14,” “LTE Rel. 15” or later versions) are under study.

In LTE Rel. 10/11, carrier aggregation (CA) to integrate multiple component carriers (CCs) is introduced in order to achieve broadbandization. Each CC is configured with the system bandwidth of LTE Rel. 8 as one unit. In addition, in CA, multiple CCs under the same radio base station (eNB (eNodeB)) are configured in a user terminal (UE (User Equipment)).

Meanwhile, in LTE Rel. 12, dual connectivity (DC), in which multiple cell groups (CGs) formed by different radio base stations are configured in UE, is also introduced. Each cell group is comprised of at least one cell (CC). Since multiple CCs under different radio base stations are integrated in DC, DC is also referred to as “inter-eNB CA.”

Also, in LTE Rel. 8 to 12, frequency division duplex (FDD), in which downlink (DL) transmission and uplink (UL) transmission take place in different frequency bands, and time division duplex (TDD), in which downlink transmission and uplink transmission switch over time and take place in the same frequency band, are introduced.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

Future radio communication systems (for example, 5G, NR, etc.) are expected to realize various radio communication services by fulfilling varying requirements (for example, ultra-high speed, large capacity, ultra-low latency, etc.).

For example, in 5G, research is underway to provide radio communication services, referred to as “eMBB (enhanced Mobile Broad Band),” “IoT (Internet of Things),” “MTC (Machine Type Communication),” “M2M (Machine To Machine),” “URLLC (Ultra Reliable and Low Latency Communications)” and so on. Note that M2M may be referred to as “D2D (Device To Device),” “V2V (Vehicle To Vehicle)” and so on, depending on what communication device is used.

For LTE Rel. 14, eLAA (enhanced License-Assisted Access), which supports UL transmission in unlicensed carriers, is under study to fulfill the requirements for various types of communication, such as those described above. For example, uplink control information (UCI) may be transmitted in unlicensed carriers.

Since an unlicensed carrier is a band that is shared by a number of businesses and/or the like, in order to transmit signals in an unlicensed carrier, LBT (Listen Before Talk) must be performed successfully first. LBT refers to a technique of “listening (sensing)” before transmitting signals, and controlling transmission based on the result of listening.

However, the method of transmitting an uplink control channel (for example, PUCCH (Physical Uplink Control CHannel)) for transmitting UCI in existing LTE might limit opportunities for transmission, if LBT is introduced. In this case, the throughput of DL communication might deteriorate.

The present invention has been made in view of the above, and it is therefore an object of the present invention to provide a user terminal and a radio communication method, whereby uplink control information can be transmitted suitably even in carriers where listening is required prior to transmission.

### Solution to Problem

A user terminal according to one example of the present invention communicates in a plurality of cells, including at least one an uplink control channel-configured cell in which an uplink control channel is configured, and this user terminal has a measurement section that executes listening for two or more cells among the plurality of cells, in a given period, and a control section that controls to transmit an uplink control signal in at least one cell where listening has succeeded.

### Advantageous Effects of Invention

According to the present invention, uplink control information can be transmitted suitably even in carriers where listening is required prior to transmission.

### BRIEF DESCRIPTION OF DRAWINGS

FIG. 1 is a diagram to show an example in which LBT fails in PUCCH transmission in an unlicensed cell;

FIG. 2 is a diagram to show an example of PUCCH transmission in an unlicensed cell, according to a first embodiment of the present invention;

FIG. 3 is a diagram to show PUCCH transmission in an unlicensed cell, according to another example of the first embodiment;

FIG. 4 is a diagram to show PUCCH transmission in an unlicensed cell, according to another example of the first embodiment;

FIG. 5 is a diagram to show an example of PUSCH transmission in an unlicensed cell, according to a second embodiment of the present invention;

FIG. 6 is a diagram to show an example of a schematic structure of a radio communication system according to one embodiment of the present invention;

FIG. 7 is a diagram to show an example of an overall structure of a radio base station according to one embodiment of the present invention;

FIG. 8 is a diagram to show an example of a functional structure of a radio base station according to one embodiment of the present invention;

FIG. 9 is a diagram to show an example of an overall structure of a user terminal according to one embodiment of the present invention;

FIG. 10 is a diagram to show an example of a functional structure of a user terminal according to one embodiment of the present invention; and

FIG. 11 is a diagram to show an example hardware structure of a radio base station and a user terminal according to one embodiment of the present invention.

### DESCRIPTION OF EMBODIMENTS

Envisaging 5G/NR, studies are in progress to use not only licensed carriers (which may be referred to as “licensed cells,” “licensed CCs,” etc.), but also unlicensed carriers (which may be referred to as “unlicensed cells,” “unlicensed CCs,” etc.) for communication. A licensed carrier is a frequency carrier that is exclusively assigned to one business. An unlicensed carrier is a frequency carrier that is shared by multiple businesses, RATs and so forth.

In licensed carriers, there is no particular limitation on the timing for transmitting signals, whereas, in unlicensed carriers, LBT (Listen Before Talk) must be performed successfully first, in order to transmit signals. LBT refers to a technique of “listening (sensing)” before transmitting signals, and controlling transmission based on the result of listening.

For LTE Rel. 14, eLAA to support UL transmission in unlicensed carriers is under research, so that, for example, transmitting UCI in unlicensed carriers will be a possibility.

Also, in enhanced carrier aggregation (eCA (enhanced Carrier Aggregation)) for Rel. 13, dual connectivity (DC) for Rel. 12 and/or others, in a given cell group, UE can transmit PUCCH only in one cell where PUCCH is configured (for example, the primary cell (PCell), a primary secondary cell (PSCell), a PUCCH SCell, and so forth). Note that a cell in which PUCCH is configured may be referred to as a “PUCCH-configured cell” (or a “cell configured with PUCCH configuration”).

Now, assuming that a cell group is comprised only of unlicensed carriers and PUCCH is configured in one cell in this cell group as in the existing method, if LBT fails in the cell where the PUCCH is configured, UE is unable to transmit the PUCCH.

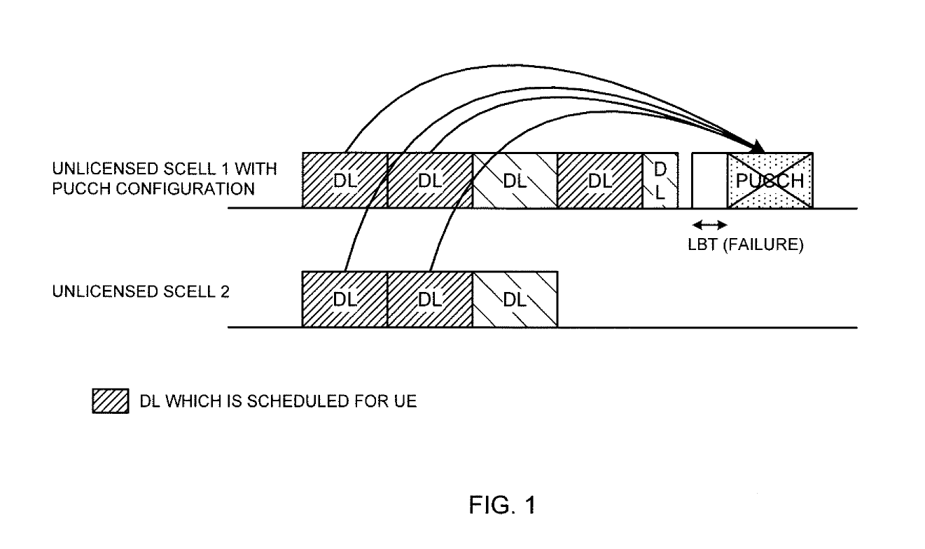

For example, FIG. 1 is a diagram to show an example in which LBT fails in PUCCH transmission in an unlicensed cell. In the example shown in FIG. 1, the UE transmits HARQ-ACKs in response to four DL subframes of two CCs (SCell 1 and SCell 2) in a PUCCH in SCell 1. Note that SCells of unlicensed carriers, such as ones shown in FIG. 1, may be referred to as “LAA SCells,” for example.

As shown in FIG. 1, while the UE performs LBT at the timing of PUCCH transmission, if this LBT fails, the UE cannot transmit the PUCCH. The radio base station, receiving no HARQ-ACK from the UE, might determine that DL transmission has failed to be delivered, and retransmit the data. In this way, when PUCCH cannot be transmitted due to the failure of LBT, unnecessary retransmission might take place in the downlink, which can cause a drop in communication throughput.

So, the present inventors have come up with the idea of increasing opportunities for transmitting PUCCH in the frequency domain (CC domain) on assumption that LBT fails.

Now, embodiments of the present invention will be described in detail below with reference to the accompanying drawings. The radio communication methods according to the herein-contained embodiments may be applied individually or may be applied in various combinations. Note that, although unlicensed carriers will be explained as examples in the following description of embodiments, the present invention can also be applied to licensed carriers, as long as listening is configured (required) in these carriers.

Also, the following embodiments will described a method of controlling which carrier is used to transmit UCI, which is to be transmitted in PUCCH, based on the premise that PUCCH transmission relates to predetermined cell groups comprised only of unlicensed carriers.

(Radio Communication Method)

### First Embodiment

The first embodiment of the present invention increases opportunities for transmitting PUCCH in the frequency domain, as mentioned earlier. For example, assuming that a predetermined group of cells are involved, multiple LAA SCells are configured for UE for transmitting PUCCH. Information about the multiple LAA SCells for PUCCH transmission may be reported to (configured in) the UE by using higher layer signaling (for example, RRC (Radio Resource Control) signaling, broadcast information (MIB (Master Information Block), SIBs (System Information Blocks) and so on), MAC (Medium Access Control) signaling, and so on), physical layer signaling (for example, DCI (Downlink Control Information) and/or other signals, or by combining these.

Before transmitting PUCCH in this predetermined cell group, the UE performs LBT (listening) in multiple LAA SCells (PUCCH SCells) that are configured. Then, (1) when LBT fails in all the PUCCH SCells, the UE drops this PUCCH transmission.

When LBT succeeds in one PUCCH SCell, the UE transmits a PUCCH in the cell where LBT succeeded. Also, when LBT succeeds in a number of PUCCH SCells, the UE (2) transmits a PUCCH only in a predetermined (specific) single cell in which LBT succeeded, or (3) transmits PUCCHs in two or more cells in which LBT succeeded. Note that, in the above case of (3), dropping rules may be defined by taking into account the possibility that transmission power can be limited (“power limited”) due to simultaneous transmission of PUCCHs.

For example, even if the UE succeeds on LBT in a number of unlicensed cells, the UE may drop PUCCHs in order, from a predetermined cell (for example, from the unlicensed cell with the largest cell index) among the unlicensed cells in which LBT succeeded, until the UE's transmission power reaches the required transmission power.

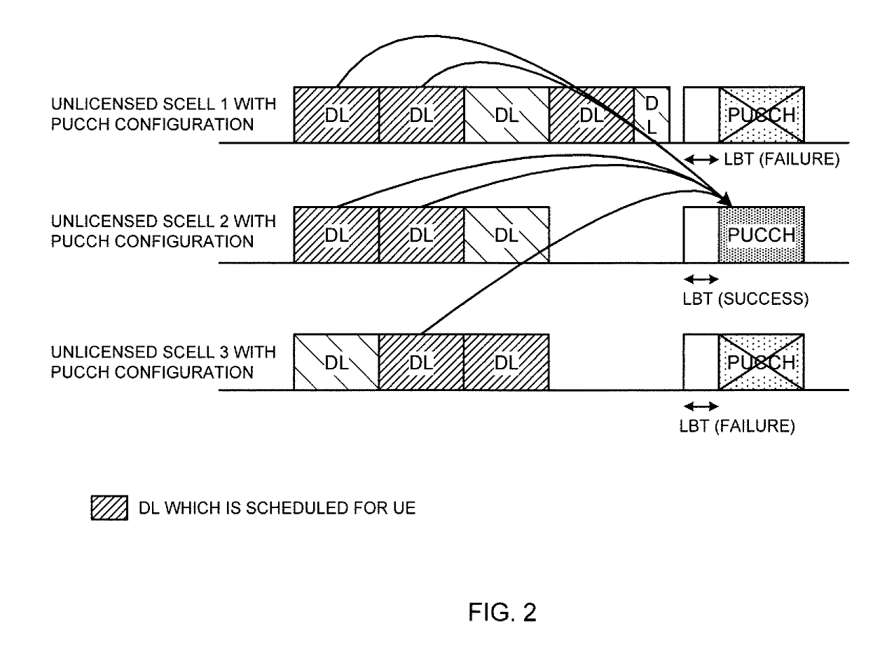

Now, with reference to FIG. 2, the first embodiment of the present invention will be described below in detail. FIG. 2 is a diagram to show an example of PUCCH transmission in an unlicensed cell according to the first embodiment. FIG. 2 shows a case where UE transmits a PUCCH that relates to a total of five DL subframes of a plurality of (for example, three) unlicensed cells (SCell 1 to SCell 3).

In FIG. 2, three unlicensed cells are configured for UE for transmitting PUCCH. That is, the UE is configured with multiple PUCCH SCells. The UE simultaneously performs LBT at the timing for transmitting PUCCH in each of the multiple unlicensed cells that are configured. Here, assume that LBT fails in SCell 1 and SCell 3, and succeeds in SCell 2. In this case, the UE cannot transmit PUCCH in SCell 1 and SCell 3, whereas, in SCell 2, where has LBT succeeded, the UE can transmit PUCCH.

In this way, a number of unlicensed cells are each granted an opportunity for transmitting PUCCH at the same timing, so that, if LBT succeeds in at least one of the unlicensed cells, the UE can transmit PUCCH. Therefore, the possibility of transmitting PUCCH successfully can be improved. As a result, it is possible to prevent unnecessary retransmission on the downlink, and to prevent a decline in communication throughput.

Also, although a case has been described with the above embodiment where three unlicensed cells are each granted an opportunity for transmitting PUCCH, this is by no means limiting. The number of unlicensed cells may be two, or may be four or more.

Also, although a case has been described with the above embodiment where LBT succeeds only in one unlicensed cell among three unlicensed cells, this is by no means limiting. For example, the following cases are also possible.

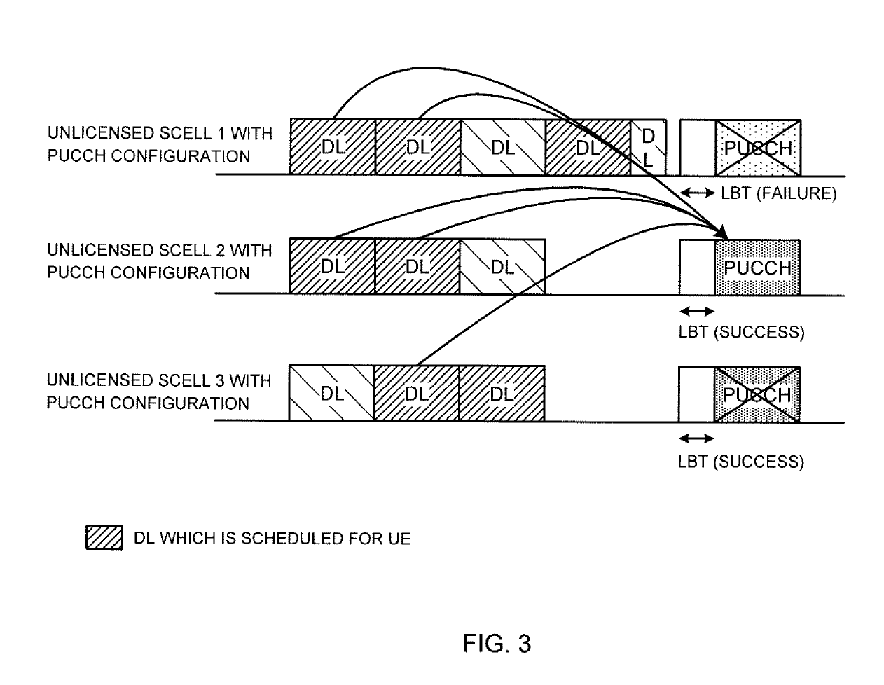

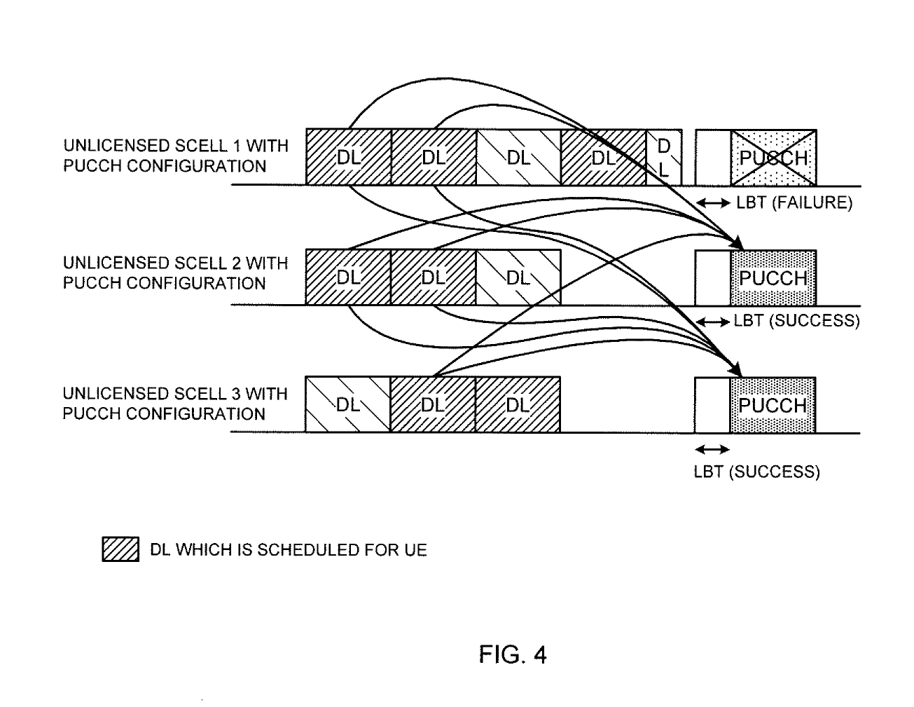

FIG. 3 and FIG. 4 are diagrams, each showing PUCCH transmission in an unlicensed cell according to another example of the first embodiment. FIG. 3 and FIG. 4 both assume a case where LBT succeeds in multiple (two out of three) unlicensed cells.

FIG. 3 shows an example in which LBT fails in SCell 1 and succeeds in SCell 2 and SCell 3. UE may transmit PUCCH in a predetermined unlicensed cell among the unlicensed cells where LBT succeeded. For example, the UE may transmit PUCCH in SCell 2 of the smaller cell index. In this case, the UE may drop (does not have to transmit) PUCCH in SCell 3. This allows the UE to transmit PUCCH in minimum required unlicensed cells, so that overhead can be reduced.

Also, as shown in FIG. 4, if LBT fails in SCell 1 and succeeds in SCell 2 and SCell 3, the UE may transmit PUCCHs in all unlicensed cells (in both SCell 2 and SCell 3) in which LBT succeeded. By this means, the radio base station can receive PUCCH more reliably. Note that, if the simultaneous transmission of the PUCCHs of SCell 2 and SCell 3 results in a power limited state, for example, the PUCCH of the unlicensed cell with the larger cell index (SCell 3) may be dropped.

According to the first embodiment described above, opportunities for transmitting PUCCH are increased in the frequency domain, so that the possibility of transmitting PUCCH successfully can be improved.

### Second Embodiment

A second embodiment of the present invention is the same as the first embodiment in that UE performs LBT in PUCCH SCells before transmitting PUCCH. According to the second embodiment, furthermore, when LBT succeeds in another unlicensed cell, in which an uplink shared channel (for example, PUSCH (Physical Uplink Shared CHannel)) is scheduled at the same timing as when PUCCH is transmitted, the UE transmits UCI in this PUSCH.

The second embodiment increases opportunities for transmitting UCI in the frequency domain. Assuming that a predetermined group of cells are involved, one LAA SCell is configured for UE for transmitting PUCCH. Information about the one LAA SCell for PUCCH transmission may be reported to (configured in) the UE through higher layer signaling (for example, RRC signaling) and so on.

Before transmitting PUCCH (transmitting UCI) in this predetermined cell group, the UE executes LBT (listening) in the one LAA SCell (PUCCH SCell) that is configured. Also, if, in a PUCCH subframe (subframe in which PUCCH transmission is attempted), PUSCH is scheduled for another unlicensed cell, the UE includes UCI in this PUSCH and transmits this (piggyback).

For example, (1) when LBT fails in all component carriers (which may be referred to as “unlicensed cells”), the UE drops this transmission of UCI. Also, (2) when LBT succeeds in one component carrier, the UE may transmit UCI in the component carrier where LBT succeeded.

Also, (3) when LBT succeeds in a number of component carriers, the UE may transmit UCI in two or more component carriers where LBT succeeded. Furthermore, (4) when LBT succeeds in a component carrier in which PUCCH is configured and in a component carrier in which PUSCH is scheduled, the UE may drop the PUCCH and transmit UCI in the PUSCH.

Note that, as in the first embodiment, dropping rules may be defined by taking into account the possibility that transmission power can be limited (“power limited”) due to simultaneous transmission of PUCCHs and/or PUSCHs. Unless power is limited, the UE may transmit one or more PUSCHs with a PUCCH, or transmit multiple PUSCHs.

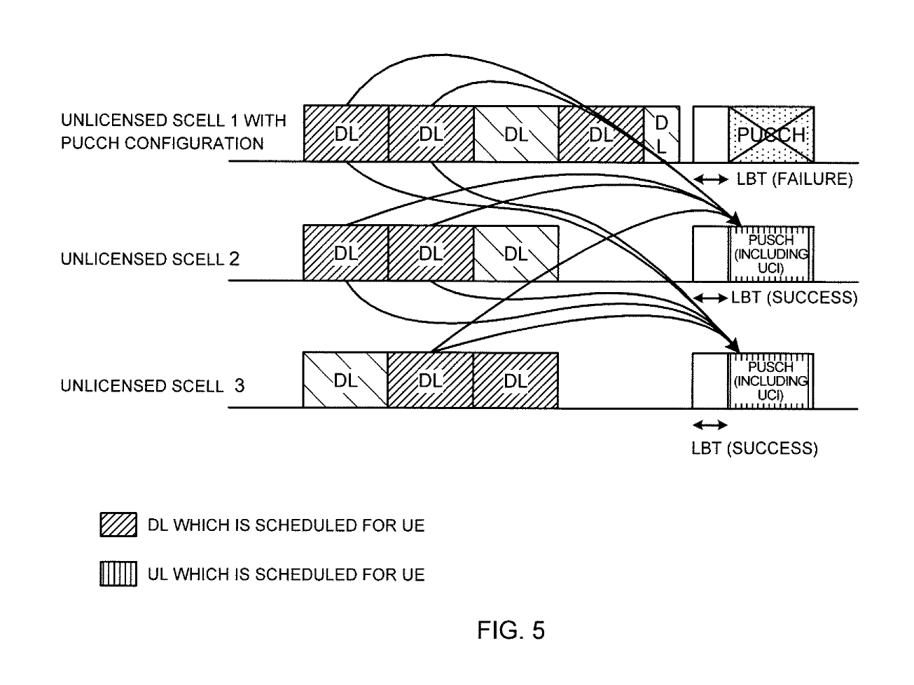

With reference to FIG. 5, the second embodiment will be described in detail below. FIG. 5 is a diagram to show an example of PUSCH transmission in an unlicensed cell according to the second embodiment.

To be more specific, in FIG. 5, PUCCH is configured in SCell 1, and, in SCell 2 and SCell 3, PUSCHs are scheduled at the same timing as the PUCCH subframe. For example, the UE executes LBT at the same timing in three unlicensed cells. As shown in FIG. 5, if LBT fails in SCell 1 and succeeds in SCell 2 and SCell 3, the UE may transmit UCI in the PUSCH in both SCell 2 and SCell 3.

Also, if LBT succeeds in an unlicensed cell in which PUCCH is configured (for example, SCell 1) among a number of unlicensed cells, the UE may transmit the UCI in the PUCCH in this SCell 1.

Furthermore, if LBT succeeds in an unlicensed cell in which PUCCH is configured and in an unlicensed cell in which PUSCH is scheduled (for example, when LBT succeeds in SCell 1 and in at least one of SCell 2 and SCell 3), the UE may drop the unlicensed cell where PUCCH is configured (SCell 1), and, in the unlicensed cell in which PUSCH is scheduled (at least one of SCell 2 and SCell 3), the UE may transmit UCI in the PUSCH.

According to the second embodiment described above, opportunities for transmitting UCI are increased in the frequency domain, so that the possibility of transmitting UCI successfully can be improved.

(Variations)

Note that the subframe structure of PUCCH in the above-described embodiments is not limited existing structures, and, for example, a predetermined gap period may be provided at the beginning and/or at the end of the subframe.

Also, although examples have been described with the above embodiments where PUCCH transmission relates to a cell group that is comprised only of unlicensed SCells, this is by no means limiting. For example, the present invention may be applied to PUCCH transmission related to a cell group comprised of an unlicensed PCell and unlicensed SCells.

Also, although examples have been described with the above embodiments where PUCCH transmission relates to a cell group that is comprised only of unlicensed carriers, this is by no means limiting. For example, even when a cell group is comprised of an unlicensed carrier and a licensed carrier, the PUCCH (UCI) transmission control method of the present invention may be used during periods in which UL transmission by the licensed carrier is not available.

Also, although examples have been described with the above embodiments where LBT for one PUCCH-configured cell and LBT for another cell are executed at the same timing, LBT for a number of unlicensed carriers has only to be executed within a predetermined period, and does not have to be executed at the same timing. For example, LBT for multiple unlicensed carriers may be executed in the same subframe (PUCCH subframe), or may be executed in different subframes.

(Radio Communication System)

Now, the structure of a radio communication system according to one embodiment of the present invention will be described below. In this radio communication system, the radio communication method according to one and/or a combination of the above-described embodiments of the present invention is used.

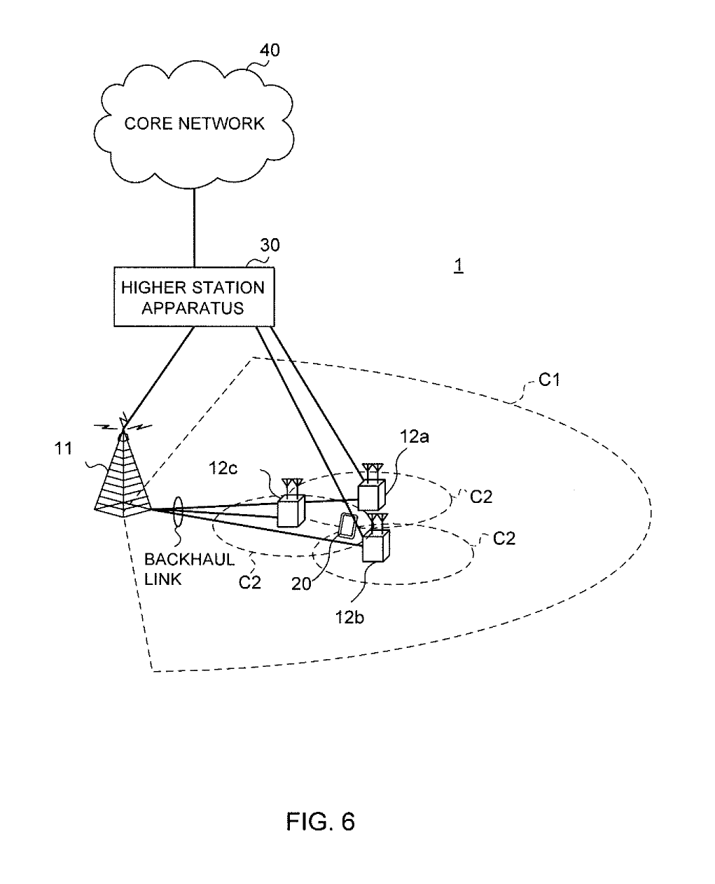

FIG. 6 is a diagram to show an exemplary schematic structure of a radio communication system according to one embodiment of the present invention. A radio communication system 1 can adopt carrier aggregation (CA) and/or dual connectivity (DC) to group a plurality of fundamental frequency blocks (component carriers) into one, where the LTE system bandwidth constitutes one unit. Also, the radio communication system 1 has a radio base station (for example, an LTE-U base station) that is capable of using unlicensed bands.

Note that the radio communication system 1 may be referred to as “SUPER 3G,” “LTE-A (LTE-Advanced),” “IMT-Advanced,” “4G (4th Generation mobile communication system),” “5G (5th Generation mobile communication system),” “FRA (Future Radio Access),” and so on.

The radio communication system 1 shown in FIG. 6 includes a radio base station 11 that forms a macro cell C1, and radio base stations 12 (12a to 12c) that are placed within the macro cell C1 and that form small cells C2, which are narrower than the macro cell C1. Also, user terminals 20 are placed in the macro cell C1 and in each small cell C2. For example, a mode may be possible in which the macro cell C1 is used in a licensed band, and the small cells C2 are used in unlicensed bands (LTE-U). Also, a mode may be also possible in which part of the small cells is used in a licensed band, and the rest of the small cells are used in unlicensed bands.

The user terminals 20 can connect with both the radio base station 11 and the radio base stations 12. The user terminals 20 may use the macro cell C1 and the small cells C2, where different frequencies are used, at the same time, by means of CA or DC. For example, it is possible to transmit assist information (for example, DL signal configuration) related to a radio base station 12 (for example, an LTE-U base station) that uses an unlicensed band, from the radio base station 11 that uses a licensed band, to the user terminals 20. Furthermore, a structure may be employed here in which, when CA is established between a licensed band and an unlicensed band, one radio base station (for example, the radio base station 1) controls the scheduling of licensed band cells and unlicensed band cells.

Note that it is equally possible to adopt a structure in which a user terminal 20 connects with a radio base station 12, without connecting with the radio base station 11. For example, it is possible to adopt a structure in which a radio base station 12 that uses an unlicensed band establishes a stand-alone connection with a user terminal 20. In this case, the radio base station 12 controls the scheduling of unlicensed band cells.

A user terminal 20 and the radio base station 11 can communicate by using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the configurations of the frequency band for use in each radio base station are by no means limited to these.

A structure may be employed here in which wire connection (for example, optical fiber, which is in compliance with the CPRI (Common Public Radio Interface), the X2 interface and so on) or wireless connection is established between the radio base station 11 and the radio base station 12 (or between two radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. Also, the radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter the radio base stations 11 and 12 will be collectively referred to as “radio base stations 10,” unless specified otherwise. Also, it is preferable to configure radio base stations 10 that use the same unlicensed band on a shared basis to be synchronized in time.

The user terminals 20 are terminals to support various communication schemes such as LTE, LTE-A and so on, and may be either mobile communication terminals or stationary communication terminals.

In the radio communication system 1, as radio access schemes, orthogonal frequency division multiple access (OFDMA) is applied to the downlink, and single-carrier frequency division multiple access (SC-FDMA) is applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combination of these.

Downlink channels that are used in the radio communication system 1 include a downlink shared channel (PDSCH (Physical Downlink Shared CHannel)), which is shared by each user terminal 20, a broadcast channel (PBCH (Physical Broadcast CHannel)), downlink L1/L2 control channels, and so on. User data, higher layer control information, SIBs (System Information Blocks) and so on are communicated in the PDSCH. Also, the MIB (Master Information Block) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ delivery acknowledgement information (ACK/NACK) in response to the PUSCH is communicated by the PHICH. The EPDCCH is frequency-division-multiplexed with the PDSCH, and used to communicate DCI and so on, like the PDCCH.

Uplink channels used in the radio communication system 1 include an uplink shared channel (PUSCH (Physical Uplink Shared CHannel)), which is shared by each user terminal 20, an uplink L1/L2 control channel (PUCCH (Physical Uplink Control CHannel)), a random access channel (PRACH (Physical Random Access CHannel)) and so on. The PUSCH may be referred to as an “uplink data channel.” User data, higher layer control information and so on are communicated by the PUSCH. Also, downlink radio quality information (CQI (Channel Quality Indicator)), delivery acknowledgement information (ACK/NACK) and so on are communicated by the PUCCH. By means of the PRACH, random access preambles for establishing connections with cells are communicated.

In the radio communication system 1, cell-specific reference signals (CRSs), channel state information reference signals (CSI-RSs), demodulation reference signals (DMRSs) and so on are communicated as downlink reference signals. Also, in the radio communication system 1, sounding reference signals (SRSs), demodulation reference signals (DMRSs) and so on are communicated as uplink reference signals. Note that DMRSs may be referred to as “user terminal-specific reference signals (UE-specific Reference Signals).” Also, the reference signals to be communicated are by no means limited to these.

(Radio Base Station)

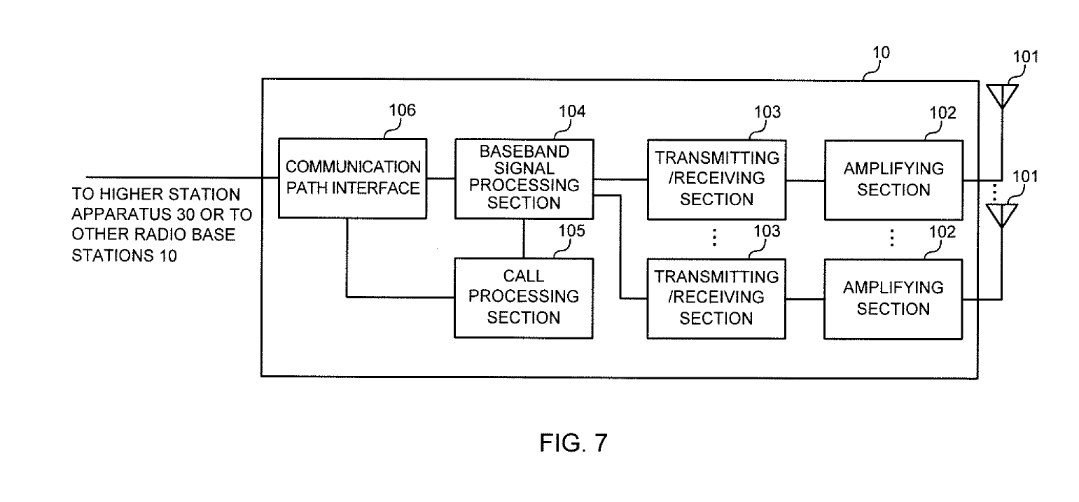

FIG. 7 is a diagram to show an exemplary overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to transmission processes, including a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to the transmitting/receiving sections 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101.

The transmitting/receiving sections 103 are capable of transmitting/receiving UL/DL signals in unlicensed bands. Note that the transmitting/receiving sections 103 may be capable of transmitting/receiving UL/DL signals in licensed bands as well. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10, and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

Note that the transmitting/receiving sections 103 receive uplink control signals in at least one cell in which listening has succeeded. Also, when listening succeeds in at least one of cells where uplink control channels are configured, the transmitting/receiving sections 103 receive uplink control signals by using the uplink control channel of the cell where listening has succeeded. Also, when listening succeeds in a cell apart from a cell where an uplink control channel is configured, the transmitting/receiving sections 103 may receive uplink control signals using an uplink shared channel. Also, when listening succeeds in two or more cells, the transmitting/receiving sections 103 may receive uplink control signals only in a predetermined cell. Also, when listening succeeds in a cell where an uplink shared channel is scheduled, the transmitting/receiving sections 103 may receive uplink signals by using the uplink shared channel in this cell.

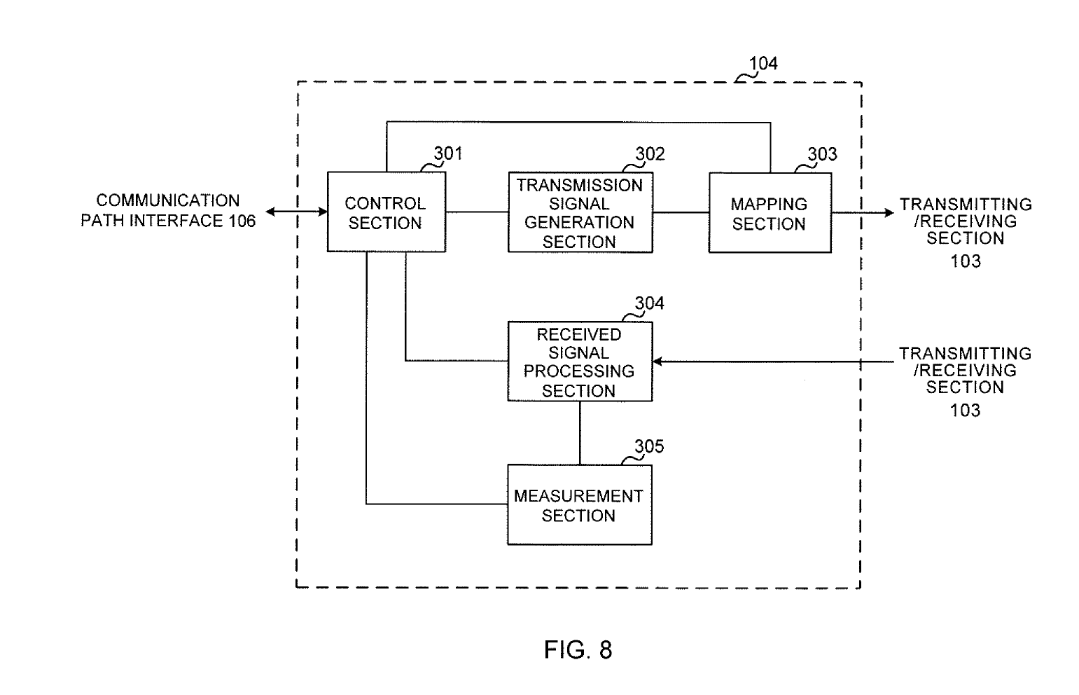

FIG. 8 is a diagram to show an exemplary functional structure of a radio base station according to one embodiment of the present invention. Note that, although FIG. 8 primarily shows functional blocks that pertain to characteristic parts of the present embodiment, a radio base station 10 has other functional blocks that are necessary for radio communication as well.

The baseband signal processing section 104 has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. Note that, when a licensed band and an unlicensed band are scheduled by one control section (scheduler) 301, the control section 301 controls communication in licensed band cells and unlicensed band cells. The control section 301 can be constituted by a controller, a control circuit or control apparatus that can be described based on general understanding of the technical field to which the present invention pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals that are transmitted in the PDSCH, and downlink control signals that are communicated in the PDCCH and/or the EPDCCH. Also, the control section 301 controls the scheduling of synchronization signals (for example, PSS (Primary Synchronization Signal)/SSS (Secondary Synchronization Signal)), downlink reference signals such as CRS, CSI-RS, DMRS and so on.

The control section 301 also controls a user terminal 20 to transmit uplink control signals in at least in one cell in which listening has succeeded. Also, when listening succeeds in at least one of cells where uplink control channels are configured, the control section 301 controls the user terminal 20 to transmit uplink control signals by using the uplink control channel of the cell where listening has succeeded. The control section 301 may also control the user terminal 20 to select the cell for transmitting uplink control signals, based on the results of listening executed in a number of cells at the same timing.

Also, when listening succeeds in a cell apart from a cell in which an uplink control channel is configured, the control section 301 may control the user terminal 20 to transmit uplink control signals by using an uplink shared channel. Also, when listening succeeds in two or more cells, the control section 301 may control the user terminal 20 to transmit uplink control signals only in a predetermined cell. Also, when listening succeeds in a cell where an uplink shared channel is scheduled, the control section 301 may control the user terminal 20 to transmit uplink signals by using the uplink shared channel in this cell.

The transmission signal generation section 302 generates downlink signals (downlink control signals, downlink data signals, downlink reference signals and so on) as commanded by the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink signal allocation information, and UL grants, which report uplink signal allocation information, as commanded by the control section 301. Also, downlink data signals are subjected to the coding process, the modulation process and so on, by using coding rates and modulation schemes that are determined based on, for example, channel state information (CSI) from each user terminal 20.

The mapping section 303 maps the downlink signals generated in the transmission signal generation section 302 to predetermined radio resources as commanded by the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals, etc.). The received signal processing section 304 can be constituted by a signal processor, a signal processing circuit or signal processing apparatus that can be described based on general understanding of the technical field to which the present invention pertains.

The received signal processing section 304 outputs the decoded information, acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present invention pertains.

The measurement section 305 may execute LBT in carriers where LBT is configured (for example, unlicensed bands) based on commands from the control section 301, and outputs the results of LBT (for example, judgment as to whether the channel state is free or busy) to the control section 301.

Also, the measurement section 305 may measure, for example, received signals' received power (for example, RSRP (Reference Signal Received Power)), received signal strength (for example, RSSI (Received Signal Strength Indicator)), received quality (for example, RSRQ (Reference Signal Received Quality)), channel states and so on. The measurement results may be output to the control section 301.

Also, where there are a number of cells, including at least one uplink control channel-configured cell in which an uplink control channel is configured, the measurement section 305 may also execute listening for two or more cells in a predetermined period. Also, the measurement section 305 may execute listening for two or more uplink control channel-configured cells in a predetermined period. The measurement section 305 may also execute listening, in a predetermined period, for an uplink control channel-configured cell, and for a cell apart from the uplink control channel-configured cell, in which an uplink shared channel is scheduled in the predetermined period.

(User Terminal)

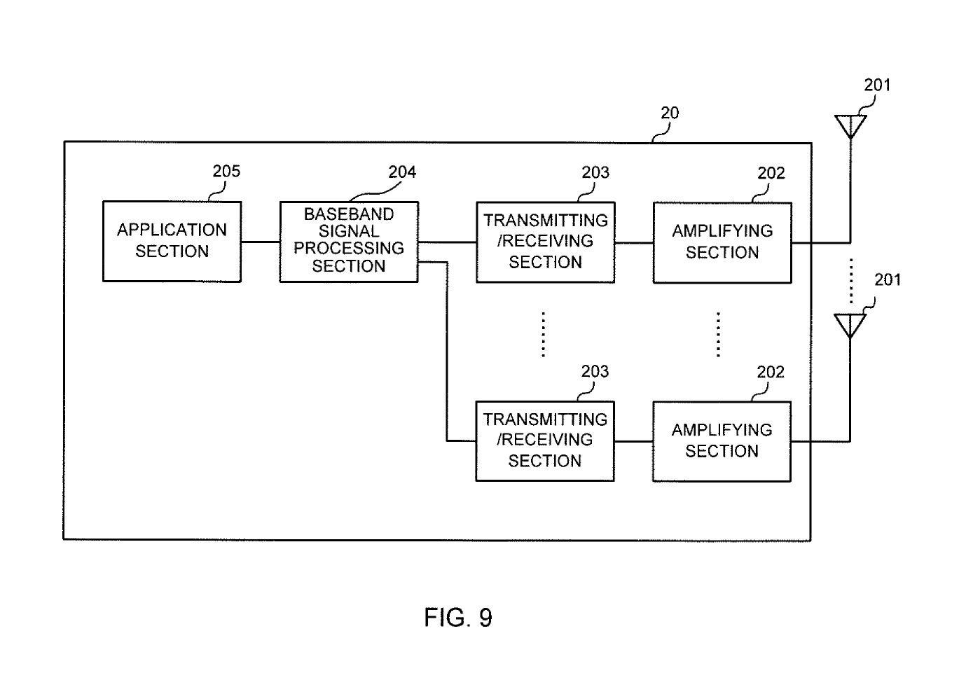

FIG. 9 is a diagram to show an exemplary overall structure of a user terminal according to one embodiment of the present invention. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. The transmitting/receiving sections 203 are capable of transmitting/receiving UL/DL signals in unlicensed bands. Note that the transmitting/receiving sections 203 may be capable of transmitting/receiving UL/DL signals in licensed bands as well.

The transmitting/receiving sections 203 can be constituted by transmitters/receivers, transmitting/receiving circuits or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203. Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 transmit uplink control signals in at least one cell in which listening has succeeded. Also, when listening succeeds in at least one of cells where uplink control channels are configured, the transmitting/receiving sections 203 transmit uplink control signals by using the uplink control channel of the cell where listening has succeeded. Also, when listening succeeds in a cell apart from a cell where an uplink control channel is configured, the transmitting/receiving sections 203 may transmit uplink control signals using an uplink shared channel. Also, when listening succeeds in two or more cells, the transmitting/receiving sections 203 may transmit uplink control signals only in a predetermined cell. Also, when listening succeeds in a cell where an uplink shared channel is scheduled, the transmitting/receiving sections 203 may transmit uplink signals by using the uplink shared channel in this cell.

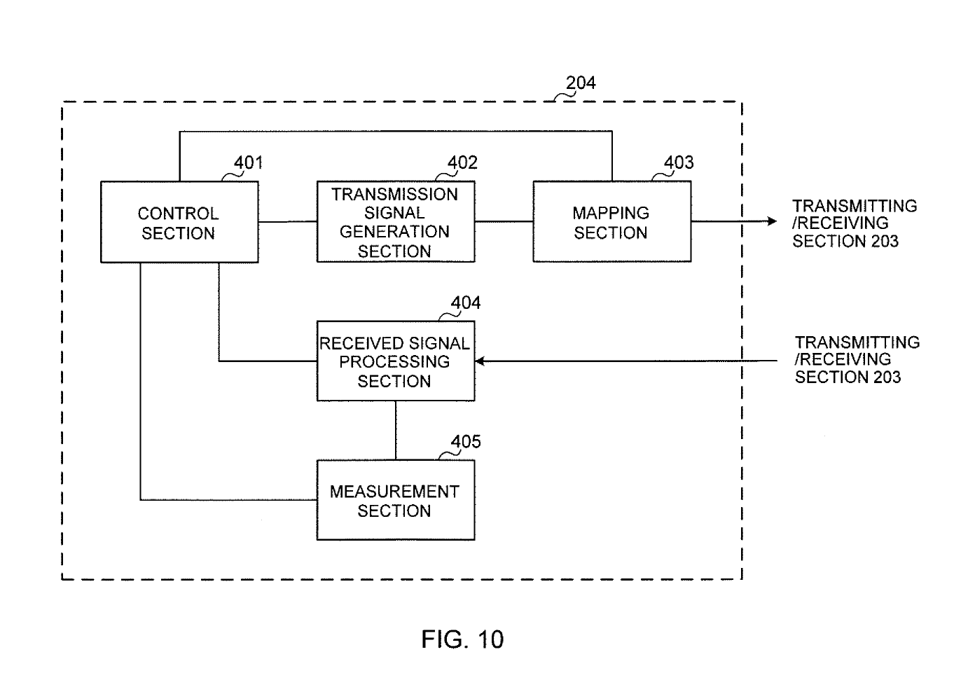

FIG. 10 is a diagram to show an exemplary functional structure of a user terminal according to one embodiment of the present invention. Note that, although FIG. 10 primarily shows functional blocks that pertain to characteristic parts of the present embodiment, the user terminal 20 has other functional blocks that are necessary for radio communication as well.

The baseband signal processing section 204 provided in the user terminal 20 at least has a control section 401, a transmission signal generation section 402, a mapping section 403, a received signal processing section 404 and a measurement section 405. Note that these configurations have only to be included in the user terminal 20, and some or all of these configurations may not be included in the baseband signal processing section 204.

The control section 401 controls the whole of the user terminal 20. The control section 401 can be constituted by a controller, a control circuit or control apparatus that can be described based on general understanding of the technical field to which the present invention pertains.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405 and so on.

The control section 401 acquires downlink control signals (signals transmitted in the PDCCH/EPDCCH) and downlink data signals (signals transmitted in the PDSCH) transmitted from the radio base station 10, via the received signal processing section 404. The control section 401 controls the generation of uplink control signals (for example, delivery acknowledgement signals (HARQ-ACK) and/or the like), uplink data signals and so on based on whether or not retransmission control is necessary, which is decided in response to downlink control signals, downlink data signals and so on.

The control section 401 exerts control so that uplink control signals are transmitted in at least one cell where listening has succeeded. Also, when listening succeeds in at least one of cells where uplink control channels are configured, the control section 401 exerts control so that uplink control signals are transmitted using the uplink control channel of the cell where listening has succeeded. Also, the control section 401 may select the cell for transmitting uplink control signals based on the results of listening executed in a number of cells at the same timing.

Also, when listening succeeds in a cell apart from a cell in which an uplink control channel is configured, the control section 401 may exert control so that uplink control signals are transmitted using the uplink shared channel. Also, when listening succeeds in two or more cells, the control section 401 may exert control so that uplink control signals are transmitted only in a predetermined cell. Also, when listening succeeds in a cell where an uplink shared channel is scheduled, the control section 401 may exert control so that uplink signals are transmitted by using the uplink shared channel in this cell.

The transmission signal generation section 402 generates uplink signals (uplink control signals, uplink data signals, uplink reference signals, etc.) as commanded by the control section 401, and outputs these signals to the mapping section 403. The transmission signal generation section 402 can be constituted by a signal generator, a signal generating circuit or signal generating apparatus that can be described based on general understanding of the technical field to which the present invention pertains.

For example, the transmission signal generation section 402 generates delivery acknowledgement signals (HARQ-ACK), uplink control signals related to channel state information (CSI) and so on, as commanded by the control section 401. Also, the transmission signal generation section 402 generates uplink data signals as commanded by the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources as commanded by the control section 401, and outputs the result to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received to signals include, for example, downlink signals (downlink control signals, downlink data signals, downlink reference signals and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 outputs the decoded information, acquired through the receiving processes, to the control section 401. The received signal processing section 404 outputs, for example, broadcast information, system information, RRC signaling, DCI and so on, to the control section 401. Also, the received signal processing section 404 outputs the received signals, the signals after the receiving processes and so on, to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

The measurement section 405 executes LBT in carriers where LBT is configured, based on commands from the control section 401. The measurement section 405 may output the results of LBT (for example, judgments as to whether the channel state is free or busy), to the control section 401.

Also, the measurement section 405 may measure, for example, received signals' received power (for example, RSRP), received signal strength (for example, RSSI), received quality (for example, RSRQ), channel states and so on. The measurement results may be output to the control section 401.

Also, where there are a number of cells, including at least one uplink control channel-configured cell in which an uplink control channel is configured, the measurement section 405 may also execute listening for two or more cells in a predetermined period. Also, the measurement section 405 may execute listening for two or more uplink control channel-configured cells in a predetermined period.

The measurement section 405 may also execute listening, in a predetermined period, for an uplink control channel-configured cell, and for a cell apart from the uplink control channel-configured cell, in which an uplink shared channel is scheduled in the predetermined period.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be implemented with one physically integrated device, or may be implemented by connecting two physically separate devices by cables or by radio, and by using these multiple devices.

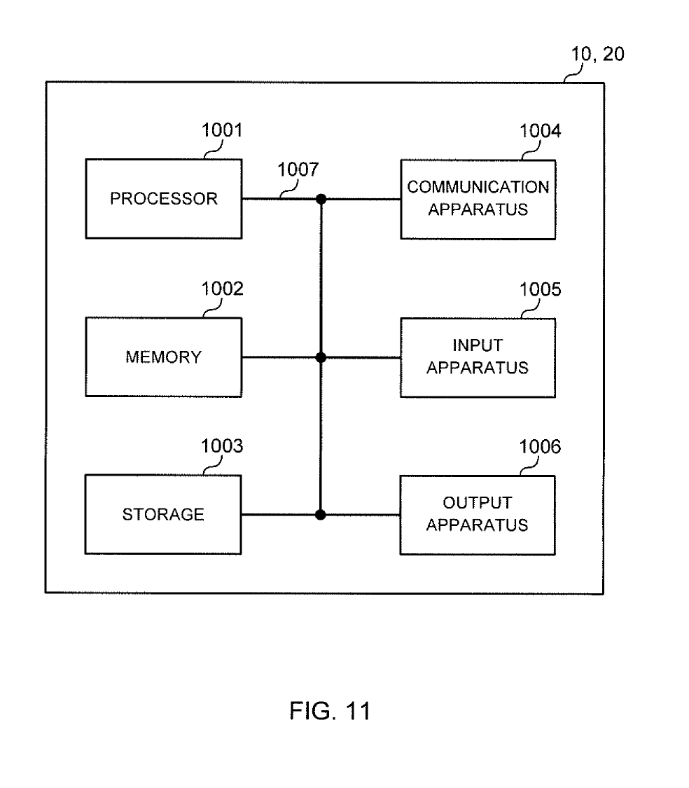

For example, the radio base station, user terminals and so on according to embodiments of the present invention may function as a computer that executes the processes of the radio communication method of the present invention. FIG. 11 is a diagram to show an exemplary hardware structure of a radio base station and a user terminal according to one embodiment of the present invention. Physically, the above-described radio base stations 10 and user terminals 20 may be formed as computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus shown in the drawing, or may be designed not to include part of the apparatus.

For example, although only one processor 1001 is shown, a plurality of processors may be provided. Furthermore, processes may be implemented with one processor, or processes may be implemented simultaneously, in sequence, or in different manners, on one or more processors.

Each function of the radio base station 10 and the user terminal 20 is implemented by reading predetermined software (program) on hardware such as the processor 1001 and the memory 1002, and by allowing the processor 1001 to do calculations and control the communication apparatus 1004 to communicate, the memory 1002 and the storage 1003 to read and/or write data, and so on.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and others may be implemented by the processor 1001.

Furthermore, the processor 1001 reads programs (program codes), software modules, data and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory (primary storage apparatus)” and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device (for example, a keyboard, a mouse and so on) for receiving input from the outside. The output apparatus 1006 is an output device (for example, a display, a speaker and so on) for allowing sending output to the outside. Note that the input apparatus 1005 and the output apparatus 1006 may be provided in an integrated structure (for example, a touch panel).

Furthermore, each apparatus, including the processor 1001 and the memory 1002, is connected via a bus 1007 for communicating information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals (or “signaling”).” Also, “signals” may be “messages.” A reference signal may be abbreviated as an “RS,” and may be referred to as a “pilot,” depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or more slots in the time domain. Furthermore, a slot may be comprised of one or multiple symbols (OFDM symbols, SC-FDMA symbols, etc.) in the time domain.

A radio frame, a subframe, a slot and a symbol all represent the time unit in signal communication. A radio frame, a subframe, a slot and a symbol may be each called by other applicable names. For example, one subframe may be referred to as a “transmission time interval (TTI),” a plurality of consecutive subframes may be referred to as a “TTI,” or one slot may be referred to as a “TTI.” That is, a subframe and a TTI may be a subframe (1 ms) in existing LTE, may be a shorter period than 1 ms (for example, one to thirteen symbols), or may be a longer period of time than 1 ms.

Here, a TTI refers to the minimum time unit of scheduling in radio communication, for example. For example, in LTE systems, a radio base station schedules allocation of radio resources for each user terminal (such as the frequency bandwidth and/or the transmission power that can be used by each user terminal), in TTI units. Note that the definition of TTIs is not limited to this. TTIs may serve as time units for transmitting channel-encoded data packets (transport blocks), or may serve as processing units in scheduling, link adaptation and so on.

A TTI having a time duration of 1 ms may be referred to as a “normal TTI (TTI in LTE Rel. 8 to 12),” a “long TTI,” a “normal subframe,” a “long subframe,” and so on. A TTI that is shorter than a normal TTI may be referred to as a “shortened TTI,” a “short TTI,” a “shortened subframe,” a “short subframe,” and so on.

A resource block (RB) is the unit of resource allocation in the time domain and the frequency domain, and may include one or a plurality of consecutive subcarriers in the frequency domain. Also, an RB may include one or more symbols in the time domain, and may be one slot, one subframe or one TTI in length. One TTI and one subframe each may be comprised of one or more resource blocks. Note that an RB may be referred to as a “physical resource block (PRB (Physical RB)),” a “PRB pair,” an “RB pair,” and so on.

Furthermore, a resource block may be comprised of one or more resource elements (REs). For example, one RE may be a radio resource field of one subcarrier and one symbol.

Note that the above-described structures of radio frames, subframes, slots, symbols and so on are merely examples. For example, configurations such as the number of subframes included in a radio frame, the number of slots included in a subframe, the number of symbols and RBs included in a slot, the number of subcarriers included in an RB, the number of symbols in a TTI, the symbol duration and the cyclic prefix (CP) duration can be variously changed.

Also, the information and parameters described in this specification may be represented in absolute values or in relative values with respect to predetermined values, or may be represented in other information formats. For example, radio resources may be specified by predetermined indices.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, a memory), or may be managed using a management table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI), etc.), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent implicitly (by, for example, not reporting this piece of information).

Decisions may be made in values represented by one bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as user terminals. For example, each example/embodiment of the present invention may be applied to a configuration in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by higher nodes (upper nodes). In a network comprised of one or more network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The examples/embodiments illustrated in this specification may be used individually or in combinations, which may be switched depending on the mode of implementation. The order of processes, sequences, flowcharts and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

The examples/embodiments illustrated in this specification may be applied to systems that use LTE (Long Term Evolution), LTE-A (LTE-Advanced), LTE-B (LTE-Beyond), SUPER 3G, IMT-Advanced, 4G (4th Generation mobile communication system), 5G (5th Generation mobile communication system), FRA (Future Radio Access), New-RAT (Radio Access Technology), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other adequate radio communication methods, and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used herein only for convenience, as a method of distinguishing between two or more elements. In this way, reference to the first and second elements does not imply that only two elements may be employed, or that the first element must precede the second element in some way.

As used herein the terms “judging” and “determining” encompass a wide variety of operations. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosure of Japanese Patent Application No. 2016-176859, filed on Sep. 9, 2016, including the specification, drawings and abstract, is incorporated herein by reference in its entirety.

1. A user terminal that communicates in a plurality of cells including at least one uplink control channel-configured cell in which an uplink control channel is configured, the user terminal comprising:
a measurement section that executes listening for two or more cells among the plurality of cells, in a given period; and
a control section that controls to transmit an uplink control signal in at least one cell where listening has succeeded.

2. The user terminal according to claim 1, wherein:
the measurement section executes listening for two or more uplink control channel-configured cells in the given period; and,
when listening has succeeded in at least one of the uplink control channel-configured cells, the control section exerts control to transmit the uplink control signal using the uplink control channel of the cell where listening has succeeded.

3. The user terminal according to claim 1, wherein:
the measurement section executes listening, in the given period, for the uplink control channel-configured cell and for a cell apart from the uplink control channel-configured cell, in which an uplink shared channel is scheduled in the given period; and
when listening has succeeded in the cell apart from the uplink control channel-configured cell, the control section exerts control to transmit the uplink control signal by using the uplink shared channel.

4. The user terminal according to claim 1, wherein, when listening succeeds in two or more cells, the control section exerts control to transmit uplink control signals only in a predetermined cell.

5. A radio communication method for a user terminal that communicates in a plurality of cells including at least one uplink control channel-configured cell in which an uplink control channel is configured, the radio communication method comprising:
executing listening for two or more cells among the plurality of cells, in a given period; and
controlling to transmit an uplink control signal in at least one cell where listening has succeeded.

6. The user terminal according to claim 2, wherein, when listening succeeds in two or more cells, the control section exerts control to transmit uplink control signals only in a predetermined cell.

7. The user terminal according to claim 3, wherein, when listening succeeds in two or more cells, the control section exerts control to transmit uplink control signals only in a predetermined cell.
